(19) United States
(12) Patent Application Publication
(10) Pub. No.: US 2021/0275284 A1
(43) Pub. Date: Sep. 9, 2021

(54) COUPLING MECHANISMS FOR TEETH-CLEANING DEVICES

(71) Applicant: ZeroBrush, Inc., Palo Alto, CA (US)

(72) Inventors: Nidhi Pai, Palo Alto, CA (US); Akash Pai, Palo Alto, CA (US); Richard K. Taylor, Fall City, WA (US); Amanda K. Woodcock, Seattle, WA (US)

(21) Appl. No.: 17/192,645

(22) Filed: Mar. 4, 2021

Related U.S. Application Data
(60) Provisional application No. 62/985,817, filed on Mar. 5, 2020.

(51) Int. Cl. A61C 17/34; A61C 17/22; A46B 9/04

(52) U.S. Cl. CPC A61C 17/3481; A61C 17/222; A46B 2200/1066; A46B 9/045; A61C 17/225

(57) ABSTRACT

The various embodiments described herein include methods, devices, systems, and associated coupling mechanisms for customized dental care. In one aspect, a dental device is customized for a particular user, including: (1) a mouthpiece assembly including: (a) a dental mouthpiece; and (b) a male connector; and (2) a drive assembly including: (a) an actuator; and (b) a female connector. The male and female connectors facilitates the correct alignment and orientation, and also efficiently transfer vibrations from the drive assembly to the mouthpiece assembly.

### RELATED APPLICATIONS

This application claims priority to U.S. Provisional Patent Application Ser. No. 62/985,817, filed on Mar. 5, 2020 entitled “Coupling Mechanisms for Teeth-Cleaning Devices.”

### TECHNICAL FIELD

This disclosure relates generally to dental care, including but not limited to, devices, systems, and associated coupling mechanisms for customized dental care.

### BACKGROUND

Toothbrushes are typically used for conventional teeth cleaning. Such toothbrushes generally have clustered bristles on a brush head that are brought into contact with a user's teeth and gums and moved about the user's mouth by the user for sequential cleaning of different areas of the user's teeth. The effectiveness of using a toothbrush to clean teeth is highly dependent on the technique and duration of the brushing, which many users find difficult to master or apply consistently.

Moreover, most toothbrushes have bristles arranged on a toothbrush head that engage with the user's teeth at an optimal angle. The Bass Technique, for example, describes an optimal brushing technique in which the toothbrush head is vibrated while in contact with the tooth at an angle of about 45°. In this approach, however, manual to and fro movement from the user may lead to gum and enamel attrition, and is therefore discouraged. It is difficult for many users, particularly for children and the elderly, to brush all teeth surfaces using the optimal technique.

Also, conventional toothbrushes are designed to clean one side of one or more adjacent teeth at any given time. For example, the brush head of a manual or powered toothbrush has a width on the order of the width of a single adult tooth. Therefore, it often takes a person 2-5 minutes to clean all of his/her teeth adequately. For example, the American Dental Association recommends brushing one's teeth for 2-3 minutes (e.g., 30 seconds per quadrant) using a manual toothbrush. Some toothbrushes even include a timer that generates an alert (e.g., a vibration) to inform a user that it is time for him/her to move from brushing one quadrant of his/her mouth to brushing another quadrant.

Unfortunately, many people brush their teeth for significantly less than the recommended length of time. For example, without a timer, a user often overestimates the length of time that the user has been brushing his/her teeth. Or a user may be in a rush. And even if the user uses a timer (e.g., a toothbrush with a quadrant timer), the user still may not brush each tooth surface within a quadrant with uniformity relative to the other tooth surfaces within the quadrant.

Furthermore, people may underbrush or overbrush. For example, people may underbrush by not following the recommended brushing process or time spent per tooth, and people may overbrush by vigorously applying pressure or abrasive action to their gums, thereby abrading their enamel or gums.

Furthermore, it can be difficult for a user to clean certain regions of his/her teeth using a conventional toothbrush. For example, it can be difficult for a user to properly engage the brush head of a conventional manual or electric toothbrush with the backs of the molars on the same side as the hand in which the user is holding the toothbrush. Moreover, a user with a sensitive mouth/throat may avoid brushing the backs of his/her molars to avoid triggering his/her gag reflex. Consequently, even people who brush their teeth regularly may not clean their teeth properly.

As such, a need has arisen for a dental device (e.g., a toothbrush) that is convenient to operate, and that can effectively clean a user's teeth.

As customized dental devices become more prevalent, a need has also arisen for coupling mechanisms that ensure that users can easily identify which customized dental devices are unique to that user (e.g., to differentiate one user's custom mouthpiece from another user's mouthpiece), and to ensure that customized dental devices are used appropriately (e.g., to ensure that a customized mouthpiece for the upper teeth is not used to brush a user's bottom teeth).

### SUMMARY

In light of these drawbacks, there is a need for a dental care system that accurately and precisely cleans and maintains a user's teeth and gums (i.e., dental health), without causing discomfort to the user, and without requiring complex or intricate dental cleaning regimes. Such systems optionally complement or replace conventional systems, devices, and methods for maintaining a user's dental health.

Accordingly, some embodiments described herein include a dental device with a customized shape with customized cleaning tips. For example, the length, shape, stiffness, and material of the cleaning tips is customized to the particular user's dentition (e.g., jaw, mouth, and teeth geometry). In accordance with some embodiments, the vibration cleaning pattern (also sometimes called a drive profile herein) is also customized for each user to produce superior cleaning of each tooth and tooth surface, hence superior whole-mouth cleaning. In some embodiments, the dental device is customized for each user's jaw and teeth geometry. In some embodiments, the cleaning tips have customized shape and/or stiffness based in part on a vibration pattern for each user.

In some embodiments, the dental device is configured to operate at a customizable range of vibration frequencies to ensure proper cleaning using multiple actuators to create different kinds of motion, which, when put together in a sequence, ensures proper whole-mouth cleaning. In some embodiments, the vibration frequencies include one or more frequencies in the sonic range and/or one or more frequencies in the ultrasonic range.

In some embodiments, the dental device is configured to gather personalized data to guide a personalized treatment plan. In some embodiments, the personalized treatment plan includes a plurality of different frequencies selected based on the user's dental information. In some embodiments, the dental device communicates with a user device (e.g., a smartphone) that allows a user to view and adjust the dental device's settings. The dental device or user device can also send feedback to the user's dental health provider (e.g., to confirm that the user is complying with a prescribed treatment regime, or for use in future diagnoses, prescriptions, and/or procedures). In some embodiments, the information about the user's dentition along with usage and feedback information from the dental device is automatically mined via AI (Artificial Intelligence) and ML (Machine Learning) to identify and/or predict dental issues and propose corresponding dental procedures. For example, identifying issues such as gum recession and propose procedures so as to improve in smile and/or overall smile and facial features.

Some embodiments include a dental device customized for a particular user. In some embodiments, the dental device includes: (1) a mouthpiece assembly including: (a) a dental mouthpiece; and (b) a male connector; and (2) a drive assembly including: (a) an actuator; and (b) a female connector. In some embodiments, there are sensors attached to the mouthpiece to detect various dental physiological parameters, such as breath analysis, bacteria detection, and the like.

With respect to coupling mechanisms, some embodiments include male and female connectors that efficiently transfer vibrations from the drive assembly to the mouthpiece assembly, and ensures the mouthpiece assembly and drive assembly engage with the correct orientation and alignment. In some embodiments, the surfaces of the male and female connectors are tapered. In some embodiments, the male and female connectors have corresponding latching mechanisms. In some embodiments, the male and female connectors have additional attachment features that further ensure correct orientation and alignment.

In some embodiments, the drive assembly and mouthpiece assembly include various features that provide feedback to the user regarding the inserted mouthpiece assembly. Some exemplary features include displays, lights, and speakers. The user receives feedback about both proper engagement of the mouthpiece assembly with the female assembly as well as information regarding the user for which the engaged mouthpiece assembly has been customized. In some embodiments, the drive assembly authenticates the mouthpiece assembly. This provides an additional check for mouthpiece assemblies tied to an existing user profile that ensures the correct mouthpiece assembly is inserted.

Thus, devices and systems are provided with methods for customizing and improving dental health, thereby increasing the effectiveness, efficiency, and user satisfaction of such devices and systems.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a schematic view illustrating a representative dental device in accordance with some embodiments.

FIG. 2A is an oblique three-dimensional view illustrating a representative drive assembly in accordance with some embodiments.

FIG. 2B is a perspective three-dimensional view illustrating a representative drive assembly in accordance with some embodiments.

FIG. 2C is a front view illustrating a representative female connector in accordance with some embodiments.

FIG. 2D is a cross-sectional side view illustrating a representative drive assembly in accordance with some embodiments.

FIG. 2E is a cross-sectional side view illustrating a representative female connector in accordance with some embodiments.

FIG. 2F is a cross-sectional side view illustrating a representative drive assembly that is engaged with a representative mouthpiece assembly.

FIGS. 3A-3C are three-dimensional views illustrating a representative mouthpiece assembly in accordance with some embodiments.

FIG. 4 is a cross-sectional side view illustrating a representative latching mechanism in accordance with some embodiments.

FIG. 5A is a perspective three-dimensional view illustrating a representative boss in accordance with some embodiments.

FIG. 5B is a perspective three-dimensional view illustrating a representative slot in accordance with some embodiments.

FIGS. 6A-6B are three-dimensional views illustrative representative electrical contacts in accordance with some embodiments. FIG. 6A shows representative electrical contacts in a representative drive assembly, while FIG. 6B shows corresponding representative electrical contacts on a representative mouthpiece assembly.

FIG. 7 is a schematic view illustrating a representative dental care system in accordance with some embodiments.

FIG. 8 is a block diagram illustrating a representative drive assembly in accordance with some embodiments.

FIG. 9 is a flowchart illustrating a method for operating a representative dental device in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Reference will now be made in detail to embodiments, examples of which are illustrated in the accompanying drawings. In the following detailed descriptions, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

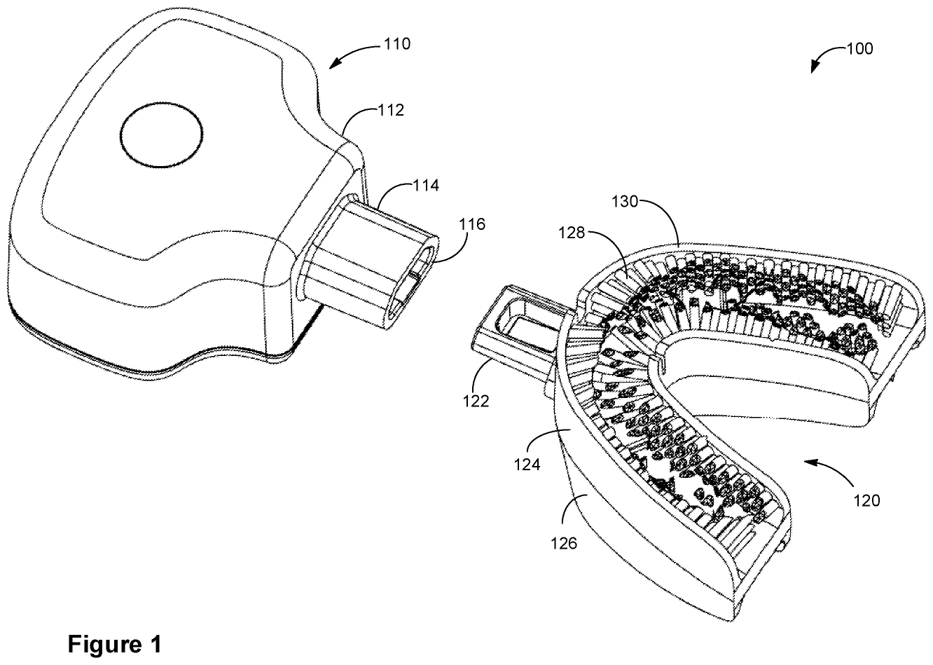

FIG. 1 shows a representative dental device 100 that is used to clean a person's teeth. Notably, the representative dental device 100 can be personalized for a particular person's teeth in order to provide the user with a comprehensive teeth-cleaning experience. As shown, the representative dental device 100 includes (i) a drive assembly 110 and (ii) a teeth cleaning mouthpiece assembly 120 (referred to henceforth as a “mouthpiece assembly 120”). The drive assembly 110 is configured to (i) couple with the mouthpiece assembly 120 (via a male connector and a female connector, discussed below), and (ii) generate vibrations that cause the mouthpiece assembly 120 to vibrate and, in turn, clean the user's teeth when positioned in the user's mouth.

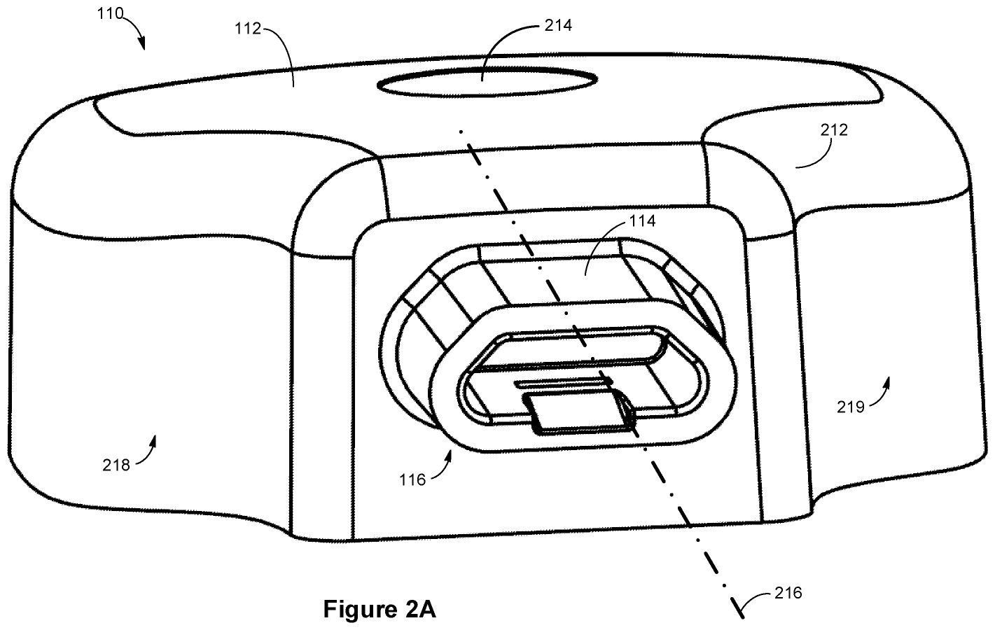

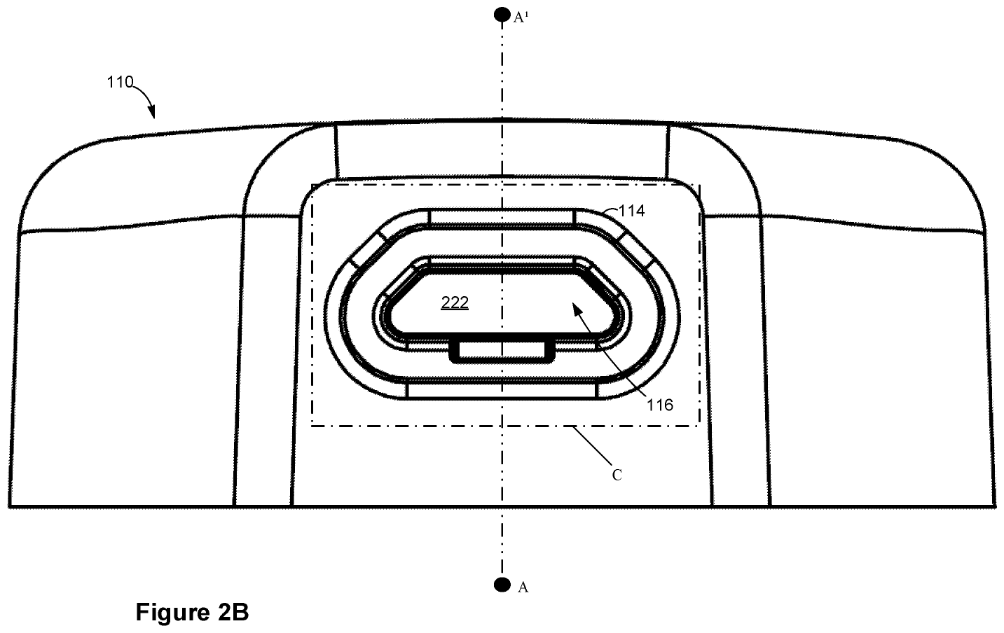

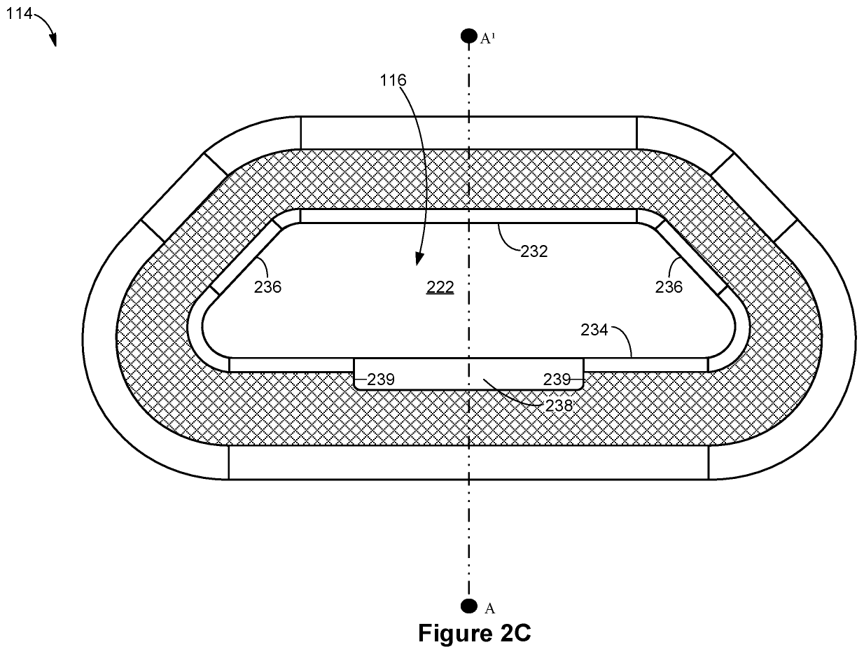

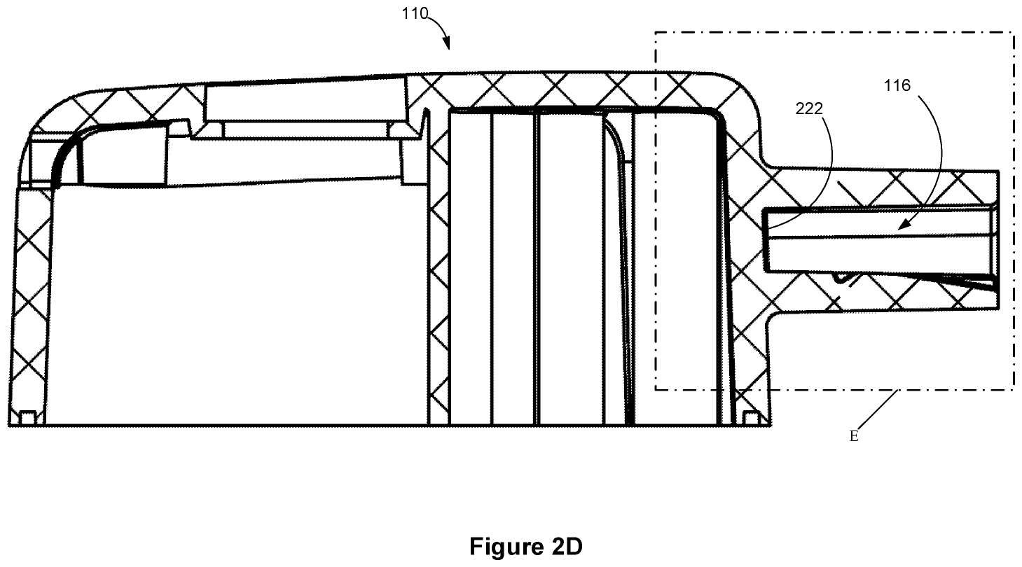

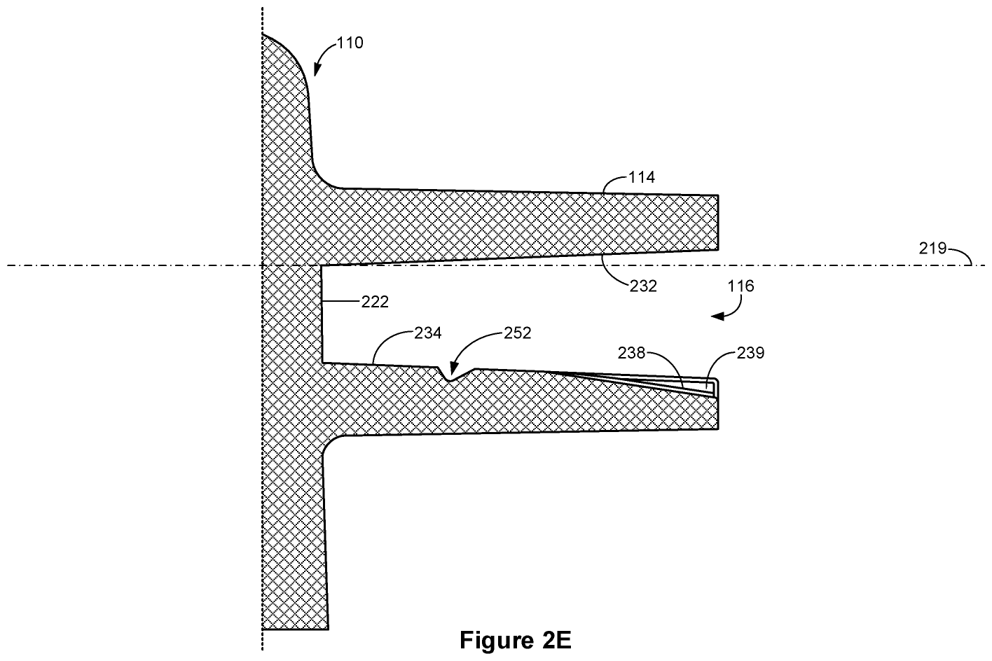

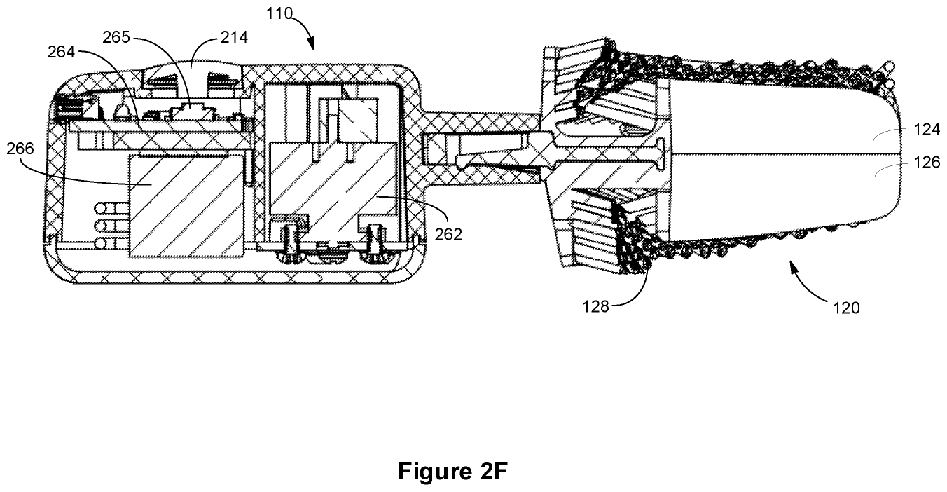

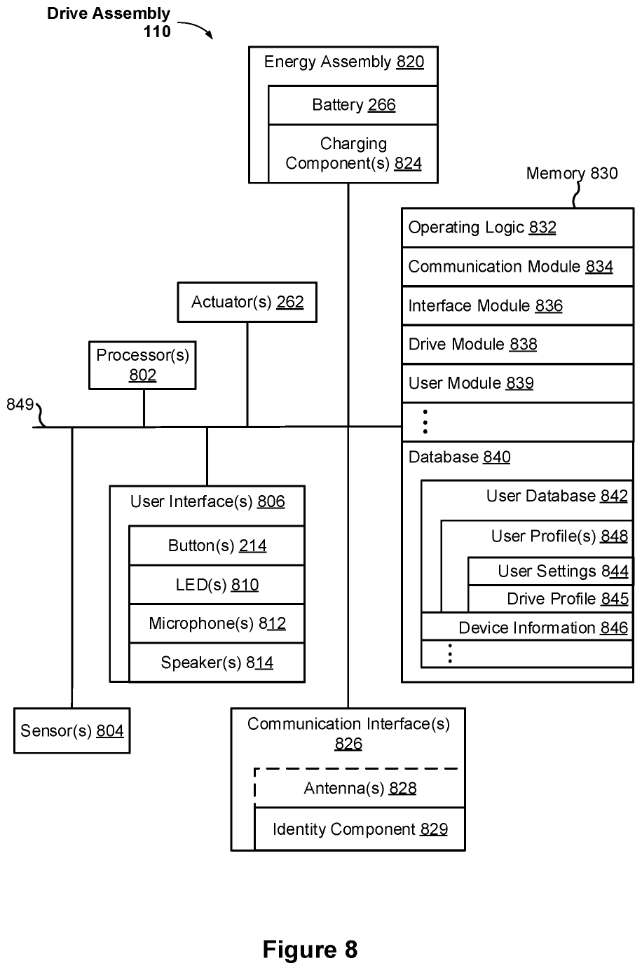

To generate the vibrations (as well as performing other functions), the drive assembly 110 includes multiple components housed within a housing 112, as shown in FIG. 2F. FIG. 2F shows the drive assembly 110 that includes an actuator 262, a circuit board 264, one or more batteries 266, etc., all of which are housed within the housing 112. Components of the drive assembly 110 are discussed in further detail below with reference to FIG. 2F and FIG. 8.

In some embodiments, with reference to FIG. 1, the drive assembly 110 also includes a female connector 114 that defines a recess 116. The female connector 114 is shaped to receive (e.g., interlock with) a male connector 122 of the mouthpiece assembly 120. It should be recognized that, in other embodiments, the mouthpiece assembly 120 includes the female connector 114 and the drive assembly 110 includes the male connector 122. For ease of discussion, however, the drive assembly 110 will be referenced as including the female connector 114, and the mouthpiece assembly 120 will be referenced as including the male connector 122. Nevertheless, in the embodiments discussed below, these components can be reversed as needed so that the mouthpiece assembly 120 includes the female connector 114 and the drive assembly 110 includes the male connector 122.

In some embodiments, the female connector 114 is integrally formed with the housing 112 (e.g., the two components are made during a single or multiple injection molding operations). In other embodiments, the female connector 114 is detachably coupled to the housing 112 (e.g., the female connector 114 is fastened to a portion of the housing 112). The female connector 114 is discussed in more detail with reference to FIGS. 2A-2E.

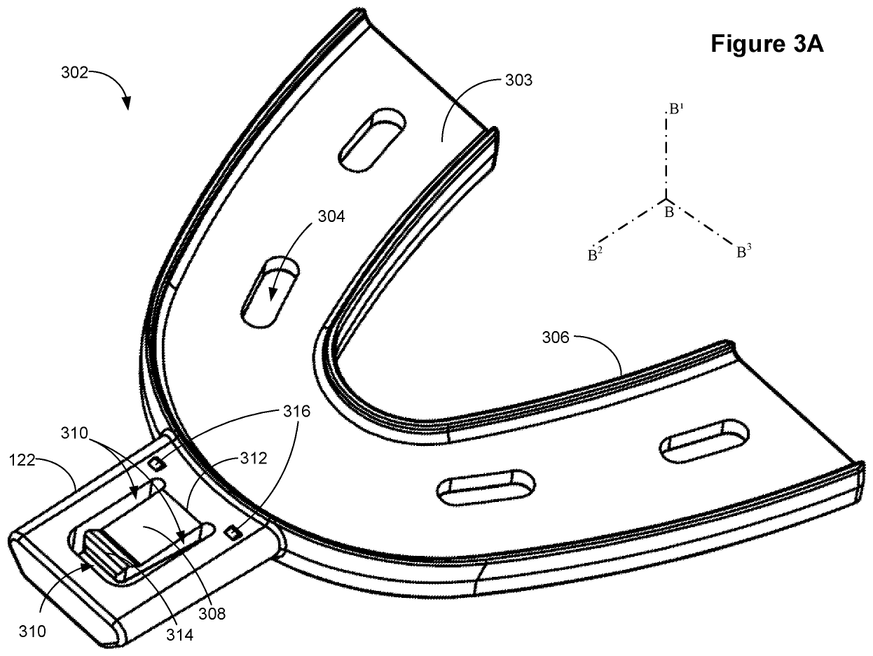

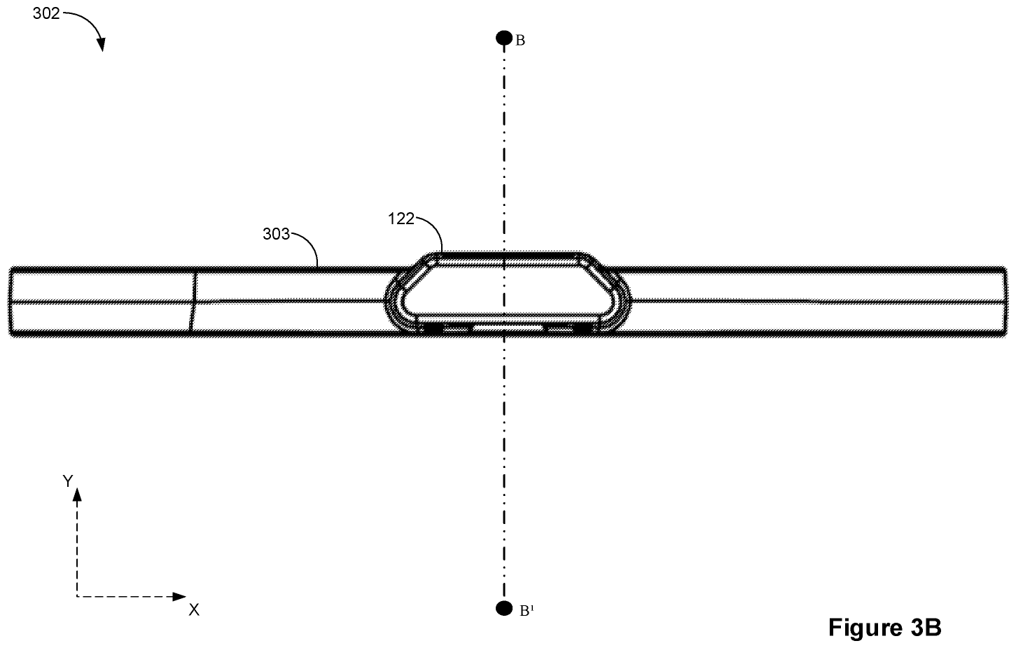

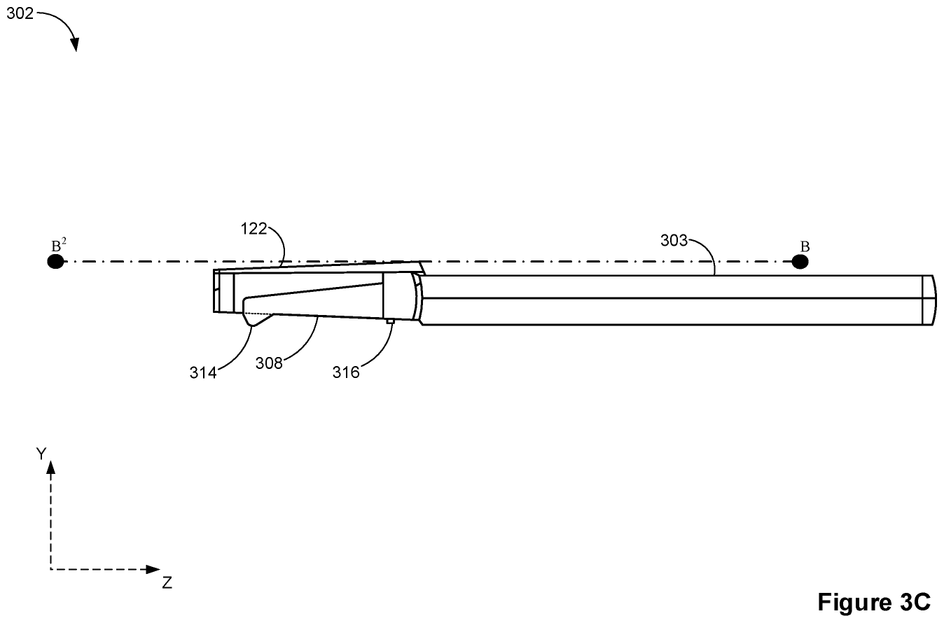

As mentioned above, the representative dental device 100 includes the mouthpiece assembly 120. As shown in FIG. 1, the mouthpiece assembly 120 includes an upper mouth tray 124, a lower mouth tray 126, cleaning tips 128, and the male connector 122. In some embodiments, the mouthpiece assembly 120 also includes a support plate 302 (shown in FIG. 3A) that is positioned between the upper mouth tray 124 and the lower mouth tray 126. In some embodiments, the male connector 122 is integrally formed with the support plate 302 (e.g., the male connector 122 and the support plate 302 are made during a single or multiple injection molding operations). In some other embodiments, the male connector 122 is detachably fastened to support plate 302.

In some embodiments, the mouthpiece assembly 120, which is optionally custom designed for a user, is configured to be inserted into the user's mouth to clean all of the user's teeth quickly and concurrently. For example, the upper mouth tray 124, the lower mouth tray 126, and/or the cleaning tips 128 are designed/configured based on a dental model of the user's teeth. Such customization of mouthpiece assembly 120 ensures proper fit and alignment of the cleaning tips 128 with respect to the user's teeth. Additionally, such customizations also allow for a more comfortable fit of the mouthpiece assembly 120 in the user's mouth.

In some other embodiments, some components of mouthpiece 120 may be standardized while other components are custom designed for a particular user. For example, walls 130 of the upper mouth tray 124 and lower mouth tray 126 may be standardized for ease of manufacture (e.g., based on the outer boundaries of a mold, or to ensure a fit with the support plate 302), while lengths, orientations, and/or spatial distributions of the cleaning tips 128 are customized based on the dental model of the user's teeth. In other embodiments, one or more components of mouthpiece 120 have both standardized and customized elements. For example, one or more cleaning tips 128 may have a set orientation (e.g., 15 degrees upward to target plaque removal at the user's gumline), while one or more cleaning tips 128 may have a custom orientation based on a dental model of the user's teeth.

The cleaning tips 128 are arranged on the upper mouth tray 124, and/or on the lower mouth tray 126, to project cantilever-fashion into the mouth tray. In some embodiments, physical properties and/or distribution density of the cleaning tips 128 vary from one part of the mouth tray to another. In some embodiments, the cleaning tips 128 have a substantially regular distribution throughout the mouthpiece 120.

FIG. 2A shows a closer view of the drive assembly 110 in accordance with some embodiments. As shown (and as mentioned above with reference to FIG. 1), the female connector 114 defines a recess 116. Notably, the recess 116 has a shape that complements a shape of the male connector 122, as shown in FIG. 1. FIG. 2A also shows an axis 216 that extends from the back of drive assembly 110 toward an opening (i.e., mouth) of the recess 116. The axis 216 runs parallel to a length of the female connector 114, and the female connector 114 is configured to receive the male connector 122 substantially along the axis 216.

In some embodiments, the housing 112 includes a button 214 that allows the user to operate the drive assembly 110. For example, the button 214 can be used to turn the drive assembly 110 on or off, change the frequency or amplitude of vibrations generated by the drive assembly 110, toggle between user profiles, etc. In some embodiments, the housing 112 includes multiple buttons (e.g., separate “up” and “down” buttons). Also, the housing 112 may include other affordances that allow the user to operate the drive assembly 110 with a finer level of granularity (e.g., affordance(s) for frequency control, affordance(s) for user profile selection, affordance(s) for brightness and volume control, etc.). In some embodiments, the housing 112 includes (in addition to or as a replacement for the button 214) a touch screen that can be used to operate the drive assembly 110. Controls of the drive assembly 110 are discussed in more detail below with reference to FIG. 8.

As also shown in FIG. 2A, the housing 112 is ergonomically shaped to comfortably fit in a user's hand. For example, edges of the housing 112 are chamfered (e.g., chamfering 212) so that the housing 112 fits comfortably in the user's hand. Additionally, the chamfering 212 can add to the aesthetic appeal of the drive assembly 110, and help reduce wear on the edges of the drive assembly 110. Additionally, the housing 112 includes the shaped portions 218 and 219 that allow the user to easily grasp the housing 112 during use.

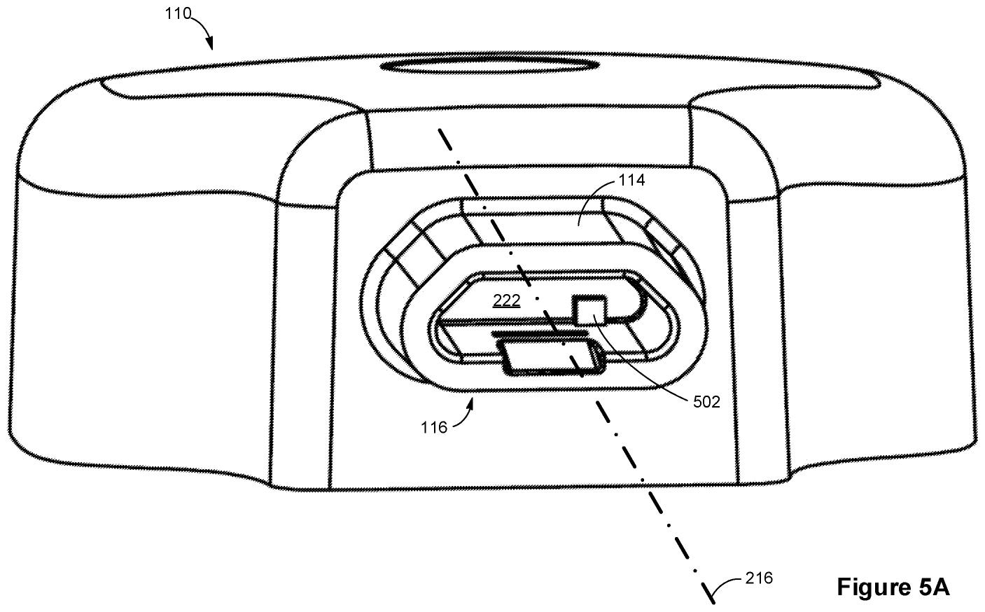

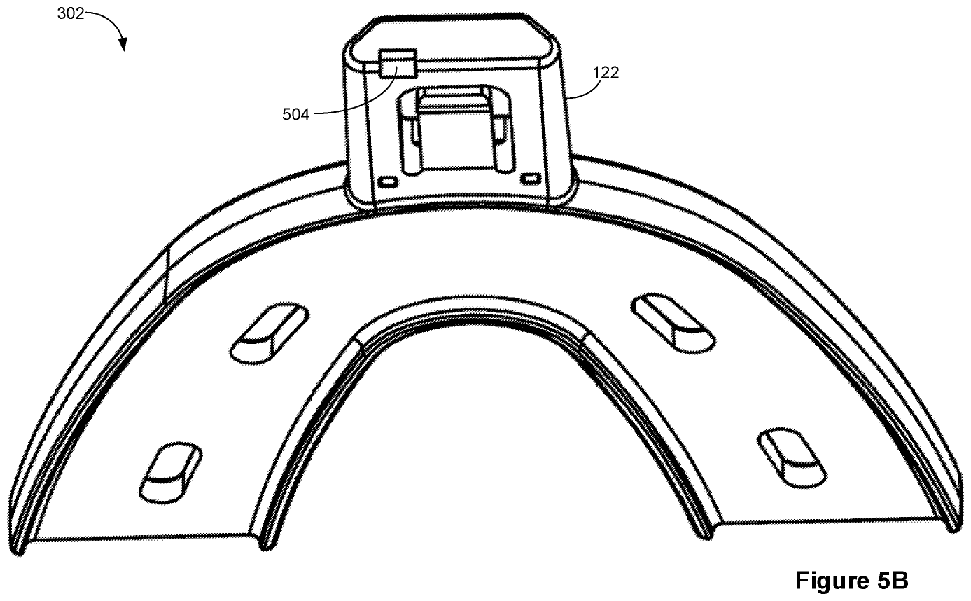

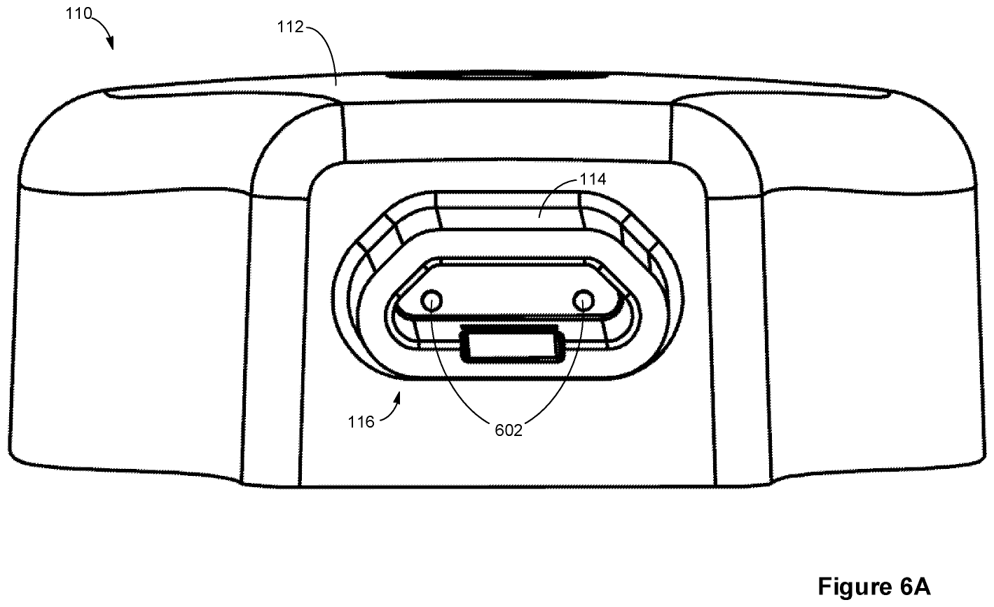

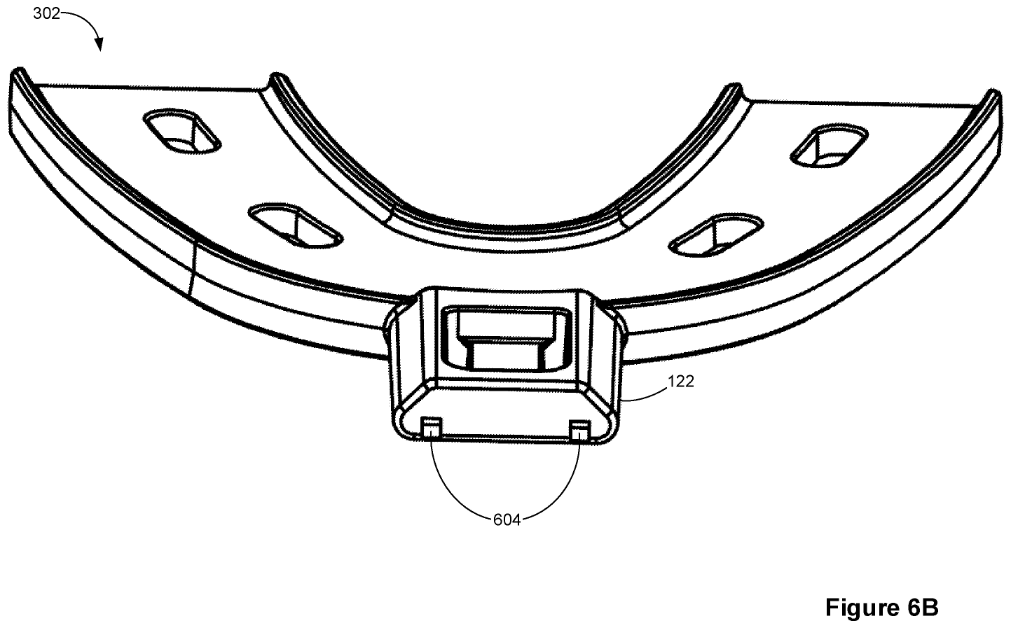

FIG. 2B shows the female connector 114 as viewed along the axis 216. As illustrated, the housing 112 defines a back wall 222 inside the female connector 114. The back wall 222 acts as an inner boundary of the recess 116. As will be explained below, one or more features of the female connector 114 may be defined relative the back wall 222. Furthermore, one or more features of the female connector 114 may be positioned on the back wall 222 (e.g., the electrical contacts 602, discussed in further detail below in reference to FIG. 6A, may be positioned on the back wall 222). In some embodiments, the back wall 222 also contains features to facilitate proper alignment or increase the strength of connection between the female connector 114 and the male connector 122. For example, with reference to FIG. 5A, the back wall 222 includes a boss 502 to help further align the female connector 114 and the male connector 122 when the male connector 122 is engaged with the female connector 114.

FIG. 2C shows a zoomed-in view (box C in FIG. 2B) of the female connector 114, as viewed along the axis 216 in FIG. 2A. As shown in the illustrated embodiment, the recess 116 has a substantially trapezoidal shape when viewed along the axis 216, and the male connector 122 has a corresponding trapezoidal shape. In some embodiments, the trapezoidal shape of the recess 116 and the male connector 122 have complementary rounded corners.

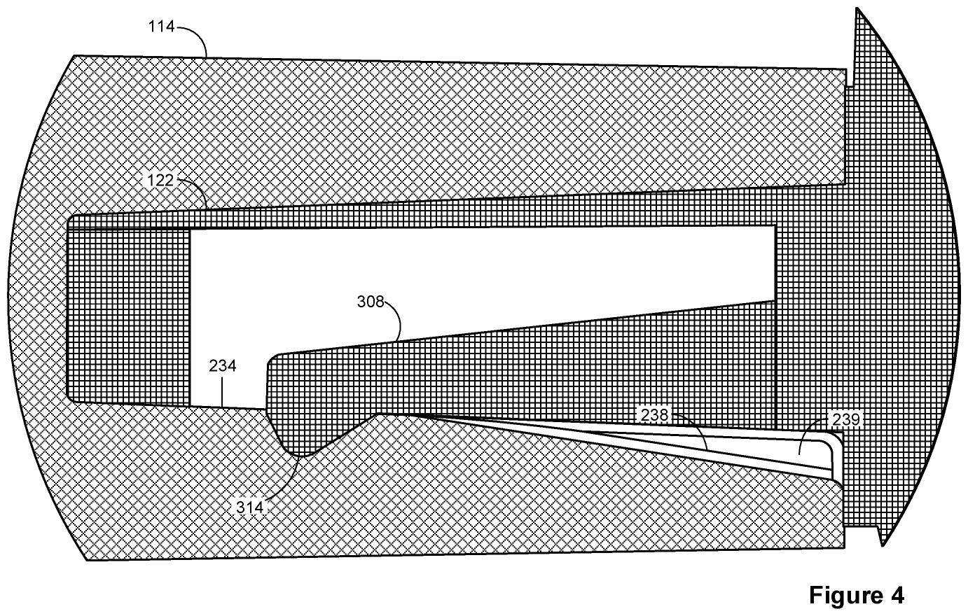

In some embodiments, the female connector 114 comprises a top surface 232, a bottom surface 234, and side walls 236 extending between the top surface 232 and the bottom surface 234. In some embodiments, the top surface 232 and the bottom surface 234 have different widths, and the side walls 236 are angled to connect the top surface 232 and the bottom surface 234. In some embodiments, the female connector 114 includes a guide surface 238 and guide walls 239. The guide surface 238 and guide walls 239 are described in further detail below, with reference to FIG. 4. In FIG. 2C, the top surface 232 is shown to be shorter than the bottom surface 234. In other embodiments, the top surface is longer (i.e., wider) than the bottom surface 234.

In some embodiments (and as mentioned above with respect to the recess 116), a substantially trapezoidal shape is defined between the top surface 232, the bottom surface 234, and the side walls 236, when viewed along the axis 216. In some embodiments, the corners connecting the top surface 232, the bottom surface 234, and the side walls are rounded (as shown FIG. 2C). In other embodiments, the corners connecting the top surface 232, the bottom surface 234, and the side walls are not rounded, such that a true trapezoidal shape is defined between the top surface 234, the bottom surface 234, and the side walls 236. In some embodiments, one or more of the top surface 232, the bottom surface 234, and the side walls 236 are curved, jagged, or otherwise non-linear. As will be explained below, in some embodiments, a cross-sectional shape of the recess 116 remains the same from a mouth of the recess 116 to the back wall 222 of the recess 116. In other embodiments, a cross-sectional shape of the recess 116 changes from a mouth of the recess 116 to the back wall 222 of the recess 116. For example, the recess 116 may taper from the mouth of the recess 116 to the back wall 222 of the recess 116. In some instances, each surface of the recess 116 is tapered, while in other instances less than all of the surfaces of the recess 116 are tapered.

FIG. 2D is a cross-sectional view (taken along line A-A¹ in FIG. 2B) of the drive assembly 110 in accordance with some embodiments. FIG. 2D shows the position of the back wall 222 inside the recess 116. For ease of illustration, components housed by the housing 112 are not shown in FIG. 2D. These components, however, are clearly shown in FIG. 2F, which is discussed below.

FIG. 2E shows an enlarged side-view of the female connector 114 (box E in FIG. 2D) in accordance with some embodiments. In some embodiments, one or more surfaces of the recess 116 may be tapered (as mentioned above), such that the recess 116 narrows from the opening/mouth of the recess 116 to the back wall 222. Put another way, at least one of the top surface 232, the bottom surface 234, or the side walls 236 is tapered such that the recess 116 narrows when view along the axis 216. In the illustrated embodiment, the top surface 232 and the bottom surface 234 in FIG. 2E are tapered such that the recess 116 is narrowest at the back wall 222. The reference line 219 (which parallels the axis 216) is shown in FIG. 2E to emphasize the tapering of the top surface 232. Note that as shown in FIG. 3C and FIG. 4, the male connector 122 includes one or more surfaces that are similarly tapered to complement the one or more tapered surfaces of the recess 116, thereby allowing the male connector 122 to properly engage with the female connector 114.

The tapered surfaces are designed to increase the coupling strength between the female connector 114 and the male connector 122. Tapered surfaces can further assist the user in successfully engaging the drive assembly 110 and the mouthpiece assembly 120. For example, the top surface 232 and the bottom surface 234 may be tapered in the same direction, making it more difficult for a user to insert the male connector 122 into the female connector 114 with the wrong orientation. Different combinations of one or more tapered surfaces can be used to accomplish this goal. Additionally, the tapered surfaces can make it easier for the user to insert the male connector 122 into the female connector 114. As the recess 116 narrows towards the back wall 222, the corresponding male connector 122 will likewise be narrowest at the end that is inserted into the female connector 114, and will be smaller than the opening of the recess 116. This allows for less than perfect accuracy in inserting the male connector 122 into the female connector 114, which can be particularly useful for users with lower dexterity (e.g., children). Lastly, due to manufacturing tolerances, tapering at least one surface of the female connector 114 and the male connector 122 ensures that the male connector 122 can be engaged with the female connector 114, as male connector 122 will be narrowest at the end that is inserted into the female connector 114.

In some embodiments, various attachment features, such as a notch 252, are included on or defined by the one or more tapered surfaces of the female connector 116. The notch 252 and other attachment features are discussed in greater detail below with reference to FIGS. 4-6.

FIG. 2F shows a schematic view of the drive assembly 110, which has been engaged with the mouthpiece assembly 120. As shown, the drive assembly 110 includes one or more actuators 262, a circuit board 264, and one or more batteries 266, each of which is described below.

The circuit board 264 includes various circuitry for communicating with other devices, storing user profile information, and operating the dental device 100. In some embodiments, the circuit board 264 is configured to receive inputs from the button 214, allowing the user to interact with the dental device. In some embodiments, the circuit board 264 is configured to control the operation of the one or more actuators 262. In some embodiments, the circuit board 264 is configured to communicate with the mouthpiece assembly 120. In some embodiments, the circuit board 264 includes a wireless transceiver 265 and memory. The wireless transceiver 265 is configured to communicate with a computer, a wireless router, or other device so that the circuity can send and receive information via the internet to/from one or more remote devices, such as a smartphone. In some embodiments, the circuitry is configurable via software, firmware, or both software and firmware, and can communicate over a wired connection or a wireless link via any suitable communication protocol such as Bluetooth® or Wi-Fi®, and via any suitable circuitry or hardware such as an RFID tag or circuitry. In some embodiments, the housing 112 includes a screen (e.g., a touch screen), one or more buttons, one or more speakers, and one or more lights. In some embodiments, the housing 112 includes one or more microphones (e.g., to enable voice commands or interact with a virtual assistant). The circuitry elements of the circuit board are discussed in further detail below with reference to FIG. 8.

In operation, the one or more actuators 262 within the drive assembly 120 are configured to generate vibrations that are propagated to the mouthpiece assembly 120 through the female connector 114 and the male connector 122. These vibrations are propagated such that the mouthpiece assembly cleans all of the user's teeth equally well or better, and in significantly less time, than a conventional manual or electric toothbrush. For example, the actuators 262 and mouthpiece assembly 120 are configured to clean a user's teeth fully, completely (e.g., to remove at least 99% of plaque buildup on the user's teeth), and uniformly within a time that ranges from approximately five seconds to approximately thirty seconds (e.g., within 20 seconds or less). Therefore, even at the high end (e.g., 30 seconds) of this time range, the dental device 100 not only cleans a user's teeth on par with, or significantly better than, conventional manual and electric toothbrushes, it also reduces the time for cleaning the user's teeth by approximately 75% as compared to the 2-minute (or more) cleaning time recommended for conventional toothbrushes.

In some embodiments, circuit board 264 is configured to control the operation of the one or more actuators 262 (e.g., piezoelectric actuators, magnetic actuators and/or offset weight motors) so as to cause cleaning of the teeth at least in part by ultrasonic action. For example, the dental device 100 is configured to generate ultrasound in order remove plaque and/or render plaque bacteria harmless. In this example, ultrasonic cleaning action includes reciprocating or oscillating movement of the mouthpiece assembly 120 at a frequency of about 1.6 MHz. In some embodiments, a movement cycle includes a linear to and fro movement and/or a circular or elliptical movement.

In some embodiments, the dental device 100 is, instead or in addition, configured for sonic cleaning, e.g., with the vibration mechanism being configured for producing at least some vibration of the cleaner tray in the audible range. In some embodiments, the frequency range of such driven movement is in the range of 200 to 400 Hz, translating to 12,000-24,000 movement cycles per minute. In some embodiments, the dental device 100 provides for user-controlled switching between sonic and ultrasonic cleaning, for example by operation of the button 214.

Fluid dynamic action caused by impelled movement of the mouthpiece assembly 120 disrupts plaque at traditionally hard-to-reach areas, such as between teeth and below the gum line. Cleaning by use of the dental device 100 thus serves not only to clean the major outer faces of the teeth, but additionally effectively performs a flossing operation by causing removal of foreign material from spaces between adjacent teeth. In some embodiments, the fluid dynamic cleaning effects operate at a distance of up to 4 mm from the contact points between the cleaning tips 140 and the teeth. Thereafter, sonic vibration is optionally produced for physically cleaning and removing the weakened or loosened materials. The vibration mechanism is in some embodiments configured such that the amplitudes of the sonic movement will typically be larger than that of movements produced during ultrasonic cleaning.

In some embodiments, the circuit board 264 is configured to allow cycling through different modes (e.g., based on repeated pressing of the button 214). In some embodiments, the different modes include an ultrasonic mode, a sonic mode, and a switched off mode. In some embodiments, the dental device 100 is preprogrammed to automatically perform a cleaning cycle (e.g., a cleaning cycle that comprises both ultrasonic and sonic vibrations) with vibrations produced in a predefined sequence. In such a case, for example, a few seconds of ultrasonic vibration may serve to generate ultrasonic waves to break up bacterial chains that make up the dental plaque and remove or weaken their methods of attachment to the tooth surface.

Returning to the drive assembly, in some embodiments, the battery 266 is a rechargeable battery, such as a lithium-ion battery. In some embodiments, the battery 266 is a rechargeable battery integrated with the other components of the drive mechanism 110 and configured to be charged from an external source. In some embodiments, the batter 266 is configured to be charged via a physical connection (e.g., a power cord). In some embodiments, the battery 266 is configured to be charged via contact-free charging (e.g., magnetic coupling, radio frequency waves). In some embodiments, the battery 266 is configured to allow removal from the drive assembly 110, either to facilitate recharging or full replacement.

FIGS. 3A-3C show multiple views of the support plate 302, without the upper mouth tray 124 or lower mouth tray 126, in accordance with some embodiments. In particular, FIG. 3A shows an oblique view of the support plate 302, FIG. 3B shows a front view of the support plate 302, and FIG. 3C shows a cross-sectional view (taken along line B-B¹ in FIG. 3B) of the support plate 302. In some embodiments, the features shown in FIGS. 3A-3C are present on a top surface of the support plate 302, while in other embodiments, the features shown in FIGS. 3A-3C are present on a bottom of the support plate 302. In still other embodiments, the features in FIGS. 3A-3C are present on both the top and bottom surfaces of the support plate 302. For ease of discussion, the features shown in FIGS. 3A-3C are referred to as being on the bottom surface of the support plate 302.

As shown in FIG. 3A, the support plate 302 includes two main components: a U-shape body portion 303 and the male connector 122. In the finished mouthpiece assembly 120 (as shown in FIG. 1), the U-shape body portion 303 of the support plate 302 is encapsulated by an elastomeric material, which forms the upper mouth tray 124 and the lower mouth tray 126. As will be explained below, the U-shape body portion 303 includes one or more features that help maintain a structural integrity of the finished mouthpiece assembly 120.

In some embodiments, the support plate 302 includes one or more slots 304. The slots 304 allow the upper mouth tray 124 and lower mouth tray 126 to be securely attached to the support plate 302 (e.g., the elastomeric material that forms the upper mouth tray 124 and the lower mouth tray 126 flows into the one or more slots 304 during the injection molding operation). The one or more slots 304 may be arranged in different formations depending on the manufacturing process (e.g., to optimize an injection molding process) or desired characteristics (e.g., structural support).

In some embodiments, the support plate 302 includes raised edges 306, which provide additional structure for securing the upper mouth tray 124 and lower mouth tray 126 to the support plate 302. For example, the elastomeric material that forms the upper mouth tray 124 and the lower mouth tray 126 solidifies onto the raised edges 306, which prevents the upper mouth tray 124 and the lower mouth tray 126 from moving laterally, at a minimum.

Turning to the male connector 122, FIG. 3A shows several attachment features of the male connector 122 in accordance with some embodiments. As shown, the male connector 122 may define a central opening 310 (which may or may not extend from the bottom surface of the male connector 122 to the top surface of the male connector 122) and may include a tongue 308 positioned in the central opening 310. In this arrangement, the tongue 308 is separated from the male connector 122 by gaps on three sides of the tongue 308, such that the tongue 308 lies within the male connector 122. Notably, the tongue 308 is connected to the male connector 122 at the connecting surface 312 in a cantilever-fashion, which allows a distal end of the tongue 308 to move upwards and downwards (e.g., along the Y-axis shown in FIG. 3C). In the illustrated embodiment, the tongue 308 is rectangular in shape and the connecting surface 312 is one side of the tongue 308′s rectangular shape. In other embodiments, the tongue 308 is attached to the male connector 122 at two locations. In some embodiments, the connecting surface 312 is a discrete element, such as a hinge. In other embodiments, the tongue 308 and the male connector 122 are integrally formed together. In such embodiments, connecting surface 312 refers to the region where the tongue 308 attaches to the male connector 122, and not to a discrete element, such as a hinge. The function of the tongue 308 is discussed below.

The tongue 308 includes a latching mechanism 314 that projects from the tongue 308. In some embodiment, the latching mechanism 314 is designed to engage with a corresponding mechanism defined by the female connector 114, such as the notch 252 in FIG. 2E. Moreover, because a distal end of the tongue 308 in able to move upwards and downwards, the latching mechanism 314 does not prevent (or otherwise obstruct) the male connector 122 from being engaged with the female connector 116. In some embodiments, the bottom surface 234 of the female connector 114 has an additional guide surface 238 (shown in FIG. 2C) to accommodate the tongue 308.

In some embodiments, the male connector 122 includes one or more protrusions 316 (sometimes called “ribs 316”) that protrude from the lower surface (and/or the upper surface) of the male connector 122. The one or more protrusions 316 are configured to interlock with corresponding cavities defined by the female connector 116 when the male connector 122 is engaged with the female connector 116. For example, if the one or more protrusions 316 are defined on a lower surface of the male connector 122, then the corresponding cavities are defined by the lower surface 234 of the female connector 116. It should be noted that, in some embodiments, the female connector 116 (instead of the male connector 122) includes the one or more protrusions 316. In such embodiments, the male connector 122 defines corresponding cavities in the locations of the one or more protrusions 316 in FIG. 3A. An example protrusion 316 is also shown in the cross-sectional view of the support plate 302 in FIG. 3C.

As mentioned above, FIG. 3B shows a front view of the support plate 302. In particular, FIG. 3B shows the support plate 302 viewed along the line B²-B in FIG. 3A. As shown, the male connector 122 has a substantially trapezoidal shape when viewed along the line B²-B. Notably, the substantially trapezoidal shape of the male connector 122 complements the shape of the female connector 114, such that the male connector 122 and the female connector 116 fit snuggly together when engaged with each other.

FIG. 3C shows a side view of the support plate 302,viewed along the line B³-B in FIG. 3A. In the shown embodiment, the male connector 122 has tapered surfaces, which complements similarly tapered surfaces of the female connector 114, such that the male connector 122 and the female connector 116 fit snuggly together when engaged with each other. FIG. 3C also shows how the latching mechanism 314 and the protrusion 316 extend from the surface of the male connector 122.

FIG. 4 shows a schematic view of the male connector 122 engaged with the female connector 114, in accordance with some embodiments. The latching mechanism 314 of the male connector 122 fits within the notch 252 of the female connector 114 (shown in FIG. 2E). The depth and shape of the notch 252 and the latching mechanism 314 may be adjusted to achieve preferred performance characteristics. For example, a deeper notch 252 with a longer latching mechanism 314 provide greater latching force and requiring more force to disengage. Alternatively, a shallower notch 252 allows the male connector 122 and the female connector 114 to be engaged and disengaged with less user effort, and can also reduce stress at the connecting surface 312.

In some embodiments, the female connector 114 includes a guide surface 238. The guide surface 238 is distinct from and has different tapering than the bottom surface 234. FIG. 4 shows the guide surface 238 with a greater degree of taper than the bottom surface 234, which continues along the top of the guide wall 239. The guide surface 238 helps accommodate features such as the latching mechanism 314 of the male connector 122. The sharper slope of the guide surface 238 reduces the necessary movement of the tongue 308 to allow the male connector 122 to fit in the female connector 114. Moreover, the guide surface 238 and the guide walls 239 also help to align the male connector 122 and ensure that the latching mechanism 314 engages with the notch 252.

In some embodiments, the guide surface 238 is positioned on (or integrated with) a portion of the bottom surface 234 as shown in FIG. 4. In other embodiments, separate from or in addition to the previous embodiment, the guide surface 234 is positioned on one or more of the other surface of the female connector 114. In some embodiments, the female connector 114 includes multiple guide surfaces 238, and the male connector 122 includes multiple tongues 308 and latching mechanisms 314.

FIGS. 5A and 5B illustrate exemplary attachment features in accordance with some embodiments. In some embodiments, as shown in FIG. 5A, the recess 112 includes a boss 502 positioned on an inner surface of the recess 116. In such embodiments, as shown in FIG. 5B, the male connector 122 includes a corresponding slot 504 configured to engage with the boss 502 of the recess 116. This boss and slot configuration is used, at least partially, to further align the male connector 122 and female connector 114. Additionally, the boss and slot prevent the male connector 112 from being inserted with the wrong orientation. This ensure the mouthpiece and the actuator are correctly aligned, which in turn ensures efficient transfer of vibrations from the actuator to the mouthpiece.

In some embodiments, the boss 502 extends from the back wall 222 towards the opening of the recess 116. In some embodiments, the boss is positioned only on the back wall 222 and is not positioned on any of the bottom, top, or side surfaces of the female connector 114. In some embodiments, the boss extends from the back wall 222 and is positioned on one or more of the surfaces of the female connector 114. For example, the boss may be positioned on (or integrated with) a portion of the bottom surface 234 of the female connector 114. In another example, separate from or in addition to the previous example, the boss may be positioned on (or integrated with) a portion of the side walls 236. In still another example, separate from or in addition to the previous example, the boss may positioned on (or integrated with) a portion of the top surface 232 of the female connector 114. In some embodiments, the boss is positioned on (or integrated with) a surface of the male connector 122, while the female connector includes the corresponding slot 504.

FIGS. 6A and 6B show male and female connectors with electrical contacts in accordance with some embodiments. In some embodiments, recess 116 includes one or more electrical contacts 602 configured to electrically engage with one or more corresponding electrical contacts included with the male connector 122. In some embodiments, as illustrated in FIG. 6A, the female connector 114 includes a first plurality of electrical contacts 602 positioned on the back wall 222 of the female connector. Correspondingly, as shown in FIG. 6B, the male connector 122 includes a second plurality of electrical contacts 604 positioned on an end of the male connector 122, so that they can engage with the first plurality of electrical contacts 602 in recess 116. Note that the first plurality of electrical contacts are electrically coupled to a controller housed by the housing 112.

In some embodiments, the electrical contacts facilitate visual confirmation that the male connector 122 has been successfully engaged with the female connector 114. For example, the drive assembly 110, the mouthpiece assembly 120, or both assemblies may contain lights that illuminate when the electrical contacts are engaged. In another example, one or more lights may change color to provide visual confirmation. Other examples of possible visual confirmations include displaying a message on a screen (e.g., a touch screen), which may also identify the user for which the mouthpiece assembly 120 has been customized. The screen can optionally display additional user-specific instructions (e.g., instructions from a dental healthcare professional) or provide device-specific information such as maintenance instructions.

In some embodiments, separate from or in addition to the previous example, the electrical contacts facilitate aural confirmation that the male connector 122 has been successfully engaged with the female connector 114. For example, aural confirmation may occur through beeps, tones, or messages to confirm the drive assembly 110 and mouthpiece assembly 120 have been successfully engaged. The aural confirmation may also include information regarding the user for which the mouthpiece assembly 120 has been customized, such as the user's name or special user-specific instructions (e.g., instructions from a dental healthcare professional).

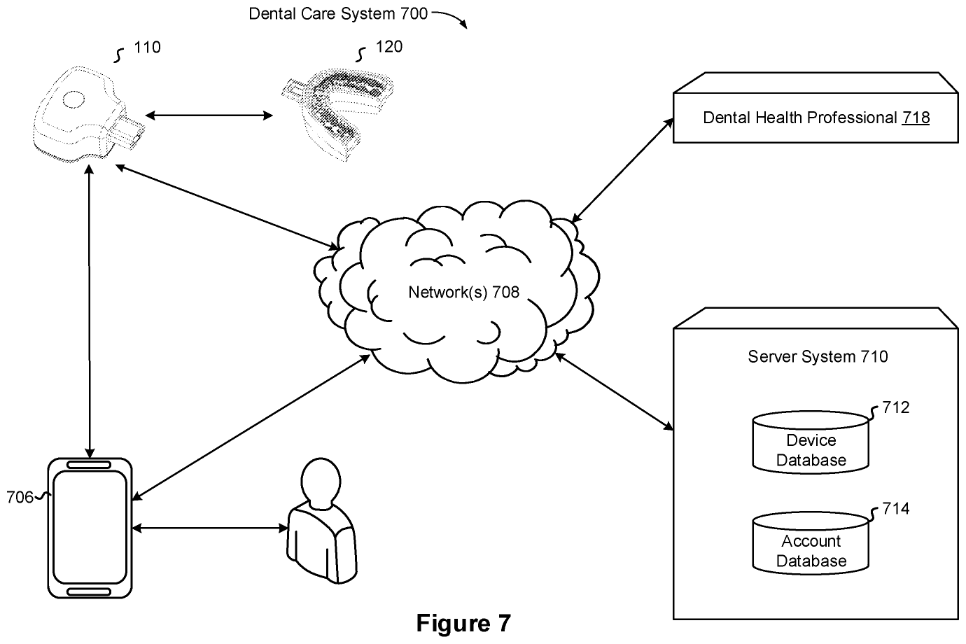

FIG. 7 is a schematic view illustrating a dental care system 700 in accordance with some embodiments. The dental care system 700 includes a drive assembly 110, a mouthpiece assembly 120, an oral care, a user device 706 (e.g., a smart phone, tablet, personal computer, or the like), a server system 710, and a dental health professional 718, communicatively coupled to one another via one or more networks 708 (e.g., one or more LANs, WANs, and/or the Internet). In some embodiments, the drive assembly 110 is directly coupled to the mouthpiece assembly 120 and/or the user device 706 (e.g., via Bluetooth protocol).

FIG. 8 is a block diagram illustrating a drive assembly 110 in accordance with some embodiments. In some implementations, the drive assembly 110 includes one or more processors (e.g., CPUs, ASICs, FPGAs, microprocessors, and the like) 802, one or more sensors 804, one or more actuator 262, one or more communication interfaces 826, memory 830, energy assembly 820, drive assembly 110, one or more user interfaces 806, and one or more communication buses 849 for interconnecting these components (sometimes called a chipset). In some implementations, the user interface(s) 806 includes one or more output devices that enable presentation of media content, including one or more LED(s) 810, one or more speakers 814, and/or one or more visual displays. In some implementations, the user interface(s) 806 also includes one or more input devices, including user interface components that facilitate user input such as a voice-command input unit or microphone 812, a touch screen display, a touch-sensitive input pad, a gesture capturing camera, or other input buttons or controls 214. Optionally, the drive assembly 110 includes a location detection component, such as a GPS (global positioning satellite) or other geo-location receiver, for determining the location of the drive assembly 110.

The one or more sensors 804 include, for example, one or more breath sensors, thermal radiation sensors, bacteria detection sensors, ambient temperature sensors, humidity sensors, IR sensors, presence sensors (e.g., using RFID sensors), ambient light sensors, motion detectors, accelerometers, and/or gyroscopes.

The communication interface(s) 826 enable the drive assembly 110 to communicate with other devices. In some implementations, the communication interface(s) 826 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document. In some embodiments, the communication interface(s) 826 includes one or more antennas 828 configured for data communications using any of a variety of custom or standard protocols (e.g., the protocols listed above). In some embodiments, the communication interface(s) 826 includes an identity component 829 configured to transmit (e.g., broadcast) an identifier for the drive assembly 110 and/or an identifier for a user of the drive assembly 110. In some embodiments, the identity component 829 comprises circuitry, memory, and/or software configured for wireless communications (e.g., using Bluetooth or Internet of Things (IoT) protocols). In some embodiments, the identity component 829 stores a unique identifier for the drive assembly 110.

In accordance with some embodiments, the energy assembly 820 includes one or more batteries 266, and optionally, one or more charging components 824. In some embodiments, the charging component(s) 824 include one or more components to enable inductive charging.

In accordance with some embodiments, the drive assembly 110 includes one or more actuators 262. In some embodiments, the one or more actuators 262 comprise one or more piezoelectric actuators, magnetic actuators, and/or offset weight motors. In some embodiments, the drive assembly 110 is configured to generate vibrations in the mouthpiece assembly 120.

The memory 830 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 830, or alternatively the non-volatile memory within memory 830, includes a non-transitory computer-readable storage medium. In some implementations, memory 830, or the non-transitory computer-readable storage medium of the memory 830, stores the following programs, modules, and data structures, or a subset or superset thereof:
Operating logic 832 including procedures for handling various basic system services and for performing hardware dependent tasks;
Communication module 834 for connecting to and communicating with other network devices (e.g., a router that provides Internet connectivity, networked storage devices, network routing devices, server system 710, user device 706, etc.) connected to one or more networks 708 via one or more communication interfaces 826 (wired or wireless);
Interface module 836 for detecting one or more user inputs or interactions and interpreting the detected inputs or interactions, and for providing and displaying a user interface in which settings, captured data, and/or other data can be configured and/or viewed;
Drive module 838 for operating the drive assembly 110, e.g., in accordance with one or more user profiles 848;
User module 839 for managing user information, such as user preferences, user settings, user dental information, user identifiers, user profiles, user dispensing profiles, and the like (e.g., a HIPPA-compliant module); and
Database 840 storing data associated with the dental device, including, but not limited to:
User database 842 storing user profile information, including user settings 844 (e.g., user interface settings and display preferences), drive profiles 845, user dental information, cached login credentials, device identifiers (e.g., MAC addresses and UUIDs), authentication tokens and tags, password keys, etc.; and
Device information 846 storing information related to the drive assembly 110 (e.g., duration and frequency of operation) and, optionally, associated devices such as the mouthpiece assembly 120 and user device 706.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 830, optionally, stores a subset of the modules and data structures identified above. Furthermore, the memory 830, optionally, stores additional modules and data structures not described above, such as a charging module configured to operate the energy assembly 820.

In some embodiments, one or more of the above identified elements is instead stored in the memory of the user device 706. In some embodiments, one or more of the above identified elements is additionally stored in the memory of the user device 706. Such embodiments provide more options for the user to interact with the device. For example, the user may find it more convenient to interact with the user device when the user is not near their drive assembly. Alternately, the user may find it more convenient to interact with the drive assembly if the user decides to make updates while, or immediately after, brushing.

In some embodiments, one or more of the components shown in FIG. 8 are located within the drive assembly 110 of dental device 100. For example, one or more of the components are arranged within the drive assembly 110. In some embodiments, one or more elements of the user interface(s) 806 are positioned on the drive assembly 110. In some embodiments, one or more of the components shown in FIG. 8 are located within the drive assembly 110, the mouthpiece assembly 120, or both the drive assembly 110 and the mouthpiece assembly 120, of dental device 100.

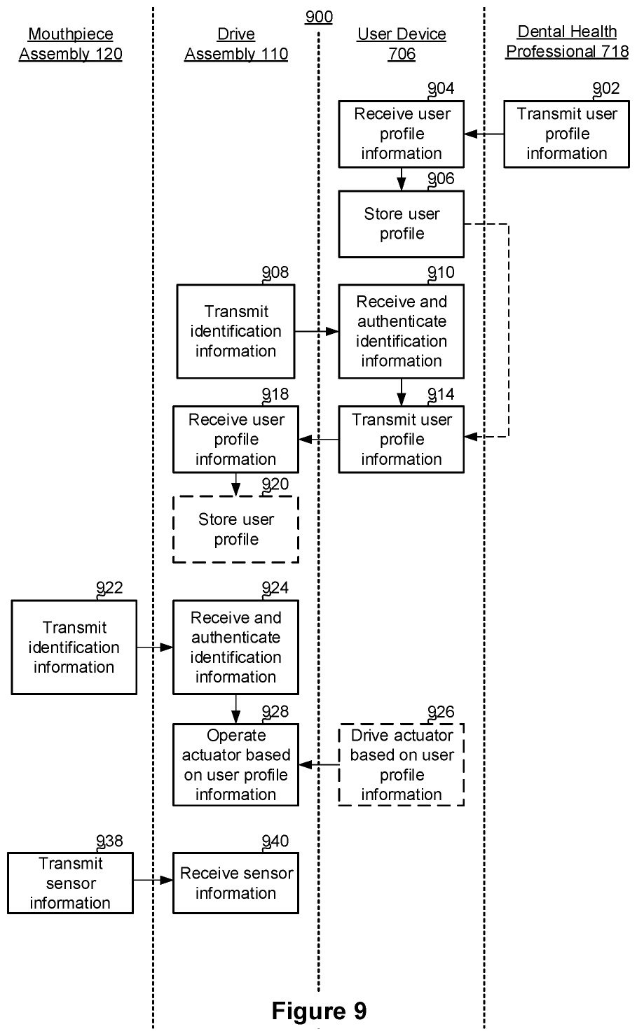

FIG. 9 is a flowchart illustrating a method 900 for operating a representative drive assembly and mouthpiece assembly in accordance with some embodiments. A dental health professional transmits (902) user profile information to a user device (e.g. smartphone device 706). In some embodiments, the dental health professional transmits the user profile information only to authorized user devices. For example, a user may first need to log into a secure application or web portal in order to authorize a user device. In some embodiments, the user profile information is based on dental details, and optionally preferences, of a user of the dental device (e.g., dental details provided by the user and/or one or more dental health professionals).

In some embodiments, the user device receives (904) the user profile information, and updates (906) a user profile stored in the memory of the user device, based on the received user profile information. In some embodiments, a new user profile is created if no corresponding user profile is already stored in the memory of the user device. In some embodiments, a user may manually configure a user profile stored in the memory of the user device, duplicate one or more user profiles stored in the memory of the user device, or manually add a new user profile to the memory of the user device. In some embodiments, portions of the user profile information may be unavailable for manual updating, or may have minimum or maximum values. In some embodiments, the portions of the user profile that are unavailable for manual updating may be selected by the dental health professional.

In some embodiments, and at any time (e.g., when turned on) the drive assembly transmits (908) identification information to the user device. In some embodiments, the identification information is transmitted via a physical connection between the user device and the drive assembly (e.g., USB-A, USB-C®, or a proprietary connector).

In some embodiments, the identification information is transmitted via any suitable communication protocol. For example, the drive assembly may send identification information via the identity component 829 of the communication interface 826. Some exemplary communication protocols include radio frequency identity (RFID) protocols, near-field communication (NFC) protocols, Bluetooth® communication protocols, and Wi-Fi® communication protocols. While any suitable communication protocol can be used for the security handshake, for ease of discussion, an exemplary security handshake process using RFID is described in further detail below.

In other embodiments, the identification information is transmitted via RFID protocol. In such embodiments, the drive assembly contains an RFID tag (e.g., the identity component 829). In some embodiments, the RFID tag is passive, including a transmitter and memory, but no power source. In some embodiments, the RFID tag receives power directly from a transmitter of the drive assembly (e.g., through the radio waves emitted by the transmitter of the user device). After receiving power, the RFID tag transmits identification information to the drive assembly. In some embodiments, the RFID tag is active and includes a power source (e.g., the battery 266 of the drive assembly). In such embodiments, the drive assembly actively broadcasts identification information without requiring an incoming signal from a user device.

The user device receives the identification information and authenticates the drive assembly (910). In some embodiments, the user device compares the received identification information against user profile information stored in the memory of the user device, and only allows transmission of user profile information if a valid match is found.

Such authentication ensures that the user device only sends user profile information to intended drive assemblies, which is particularly important if the user profile information contains sensitive patient data. If the authentication is successful, the user device transmits (914) user profile information and the drive assembly receives (918) the user profile information for the user. In some embodiments, the authentication can be bypassed or completed manually, such as in cases where a user seeks to pair a new drive assembly with the user device for the first time.

In some embodiments, the drive assembly also authenticates the user device through similar methods. In such embodiments, no user profile information is transmitted unless the user device authenticates the drive assembly and the drive assembly authenticates the user device. Such dual authentication is desirable because the drive assembly can also store user profile information in memory, which may be transmitted to the user device. The dual authentication prevents unauthorized user devices from accessing user profile information stored on the drive assembly. Additionally, dual authentication can prevent user profile information stored in the memory of the drive assembly from being edited or deleted by unauthorized user devices.

In some embodiments, the user device optionally transmits (914) the user profile information to the dental healthcare professional. For example, if the user makes a manual update to a user profile on the user device, the updated information can be sent to the dental healthcare professional. This can help to provide feedback to the dental health professional and may assist in ensuring the dental health professional has the most recent user profile information for the user.

The user device transmits (914) the user profile information to the drive assembly (e.g., drive assembly 110, FIGS. 1 and 10). The drive assembly receives (918) the user profile information and optionally updates (920) the stored user profile information with the received user profile information. In some embodiments, the user profile information is stored by both the user device and the drive assembly. In other embodiments, the user profile information is stored only by the user device, or only by the drive assembly.

In some embodiments, if no corresponding user profile is found in the memory of the drive assembly, a new user profile is created. In some embodiments, a user may manually configure a user profile stored in the memory of the drive assembly, duplicate one or more user profiles stored in the memory of the drive assembly, or manually add a new user profile to the memory of the drive assembly. In some embodiments, portions of the user profile information may be unavailable for manual updating, or may have minimum or maximum values. In some embodiments, the portions of the user profile that are unavailable for manual updating may be selected by the user and/or dental health professional.

In some embodiments, the mouthpiece assembly transmits (922) identification information to the drive assembly. In some embodiments, the identification information is transmitted via the electrical contacts of the male connector (described above with reference to FIG. 6B). In such embodiments, the drive assembly receives the transmitted identification information via the corresponding electrical contacts of the female connector (described above with reference to FIG. 6A).

In other embodiments, the identification information is transmitted via any suitable communication protocol. Some exemplary communication protocols include radio frequency identity (RFID) protocols, near-field communication (NFC) protocols, Bluetooth® communication protocols, and Wi-Fi® communication protocols. While any suitable communication protocol can be used for the security handshake, for ease of discussion, an exemplary security handshake process using RFID is described in further detail below.

In some embodiments, the identification information is transmitted via RFID protocol. In such embodiments, the mouthpiece assembly contains an RFID tag. In some embodiments, the RFID tag is passive, including a transmitter and memory, but no power source. In some embodiments, the RFID tag that is activated by the drive assembly (e.g., by providing power through the electrical contacts described with reference to FIG. 6A and 6B). In some embodiments, the RFID tag receives power directly from a transmitter of the drive assembly (e.g., through the radio waves emitted by the transmitter of the drive assembly). After receiving power, the RFID tag transmits identification information to the drive assembly. In some embodiments, the RFID tag is active and includes a power source. In such embodiments, the drive assembly actively broadcasts identification information without requiring an incoming signal from the drive assembly.

The drive assembly receives and authenticates (924) the identification information. In some embodiments, the drive assembly compares the received identification information to an identifier tied to a stored user profile. This type of information can be used to ensure the inserted mouthpiece assembly is tied to an existing user. For example, the user profile 848 in the memory 830 of the drive assembly contains an identifier of a first user. In such embodiments, the drive assembly matches the received identification information against the identifier of the first user.

In other embodiments, separate from or in addition to the previous embodiment, the drive assembly compares the received identification information to an identifier stored in the memory that is not specific to a particular user profile. For example, the identification information may include model number or product information, which can be compared against an identifier stored in the memory of the drive assembly to ensure compatibility of the mouthpiece and drive assemblies.

In some embodiments, if the authentication is successful, the drive assembly operates (928) the actuator in accordance with the user profile information. In some embodiments, the drive assembly modifies one or more of the frequency or amplitude of the vibrations produced by the actuator, in accordance with the drive profile information of the selected user profile.

In some embodiments, the user device does not transmit user profile information to the drive assembly at all, and, instead, directly transmits instructions to drive (926) the actuator in accordance with the user profile information.

In some embodiments, the drive assembly optionally transmits user profile information back to the user device, the dental health professional, or both. In some embodiments, the drive assembly transmits the user profile information back to the user device, and the user device transmits the user profile information to the dental health professional. The user device and/or dental health professional receives the user profile information and may update stored user profile information accordingly. As part of the user profile information, the user device logs device information such as duration and frequency of operation, which can provide useful feedback to the user and/or dental health professional regarding the user's brushing habits. The device information can also be used to generate data sets for applicable dental care AI or ML algorithms.

In some embodiments, the drive assembly optionally transmits user profile information to the mouthpiece assembly. The mouthpiece assembly receives the user profile information, then operates the mouthpiece in accordance with the user profile information. In some embodiments, this user profile information includes instructions for performing various functions, such as emitting ultraviolet (UV) light. In some embodiments, the mouthpiece assembly is operated independently of the drive assembly. In other embodiments, the mouthpiece assembly is operated concurrently with the drive assembly.

The mouthpiece assembly transmits (938) sensor information back to the drive assembly and the drive assembly receives (940) the sensor information. Some examples of sensor information include duration and frequency of operation, which can be provided to the user, the user device, and/or the dental health professional. In some embodiments, the drive assembly stores the sensor information in memory. In some embodiments, the drive assembly transmits the sensor information to the user device, the dental health professional, or both. In some embodiments, the drive assembly transmits the sensor information to the user device, and the user device transmits the sensor information to the dental health professional. The user device and dental health professional optionally store the sensor data.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A dental product, comprising:
a teeth-cleaning mouthpiece comprising a first connector;
a drive mechanism, comprising:
a housing;
an actuator at least partially housed by the housing; and
a second connector, coupled to the housing, that is shaped to receive the first connector, wherein on of the first or second connectors comprise:
a top surface with a first width;
a bottom surface with a second width different from the first width; and
side walls extending between the top and bottom surfaces;
a recess is defined between: the top surface, the bottom surface, and the side walls, for receiving the other of the first or second connector; and
wherein the actuator is configured to vibrate the teeth-cleaning mouthpiece at one or more desired frequencies via the coupled first and second connectors.

2. The dental product of claim 1, wherein the first connector is a male connector and the second connector is a female connector.

3. The dental product of claim 2, wherein:
the recess has a shape that complements the shape of the male connector;
the female connector is configured to receive the male connector along an axis; and
the recess has a substantially trapezoidal shape when viewed along the axis.

4. The dental product of claim 2, wherein:
the recess comprises an opening for receiving the male connector;
a back wall of the female connector forms an inner boundary of the recess; and
at least one of the top surface, the bottom surface, and the side walls is tapered such that the recess narrows, at least partially, from the opening to the back wall.

5. The dental product of claim 2, wherein:
the female connector further comprises a boss positioned on an inner surface of the recess; and
the boss is configured to engage with a corresponding slot defined by the male connector when the male connector is engaged with the female connector.

6. The dental product of claim 5, wherein:
the housing defines a back wall of the female connector; and
the boss extends from the back wall toward the opening of the recess.

7. The dental product of claim 2, wherein the female connector further comprises an electrical contact configured to electrically engage with a corresponding electrical contact included with the male connector when the male connector is engaged with the female connector.

8. The dental product of claim 2, wherein:
the female connector defines a notch in an inner surface of the recess; and
the notch is configured to engage with a corresponding latch of the male connector when the male connector is engaged with the female connector.

9. The dental product of claim 2, further comprising:
communication circuitry configured to receive, from a remote source, user profile information for a first user, wherein the user profile information includes one or more instructions for managing operation of the actuator; and
control circuity configured to control the actuator in accordance with the user profile information.

10. The dental product of claim 9, wherein the control circuitry is further configured to send signals to the teeth-cleaning mouthpiece.

11. The dental product of claim 9, further comprising memory configured to store the user profile information.

12. The dental product of claim 11, wherein:
the user profile information comprises an identifier for the first user;
the control circuitry is further configured to:
compare the identifier for the first user with identification information associated with the teeth-cleaning mouthpiece; and
authorize operation of the actuator in response to determining that the identifier for the first user matches the identification information associated with the teeth-cleaning mouthpiece.

13. The dental product of claim 12, wherein the control circuitry is further configured to compare the identifier for the first user with the identification information associated with the teeth-cleaning mouthpiece when the male connector is engaged with the female connector.

14. The dental product of claim 12, further comprising one or more lights, wherein the control circuity is further configured to illuminate at least one light of the one or more lights when the male connector is engaged with the female connector.

15. The dental product of claim 14, wherein the control circuity is further configured to illuminate the at least one light of the one or more lights in response to determining that the identifier for the first user matches the identification information associated with the teeth-cleaning mouthpiece.

16. The dental product of claim 11, further comprising a display configured to present information to a user, wherein information presented by the display is at least partially based on the user profile information of the first user.

17. The dental product of claim 11, comprising one or more speakers, wherein at least one speaker of the one or more speakers is configured to output auditory information based at least partially on the user profile information of the first user.

18. The dental product of claim 11, further comprising a button that, when pressed, toggles between different user profiles stored in the memory.

19. A teeth-cleaning mouthpiece for a dental hygiene product, comprising:
a curved mouthpiece configured to receive a user's teeth and clean the user's teeth when vibrated; and
a first connector, integrated with the curved mouthpiece, that is shaped to receive a second connector integrated with a separate drive mechanism of the dental hygiene product, wherein the drive mechanism is configured to vibrate the second connector, which causes the teeth-cleaning mouthpiece to vibrate at one or more desired frequencies when the first connector is engaged with the second connector.

20. The teeth-cleaning mouthpiece of claim 19, wherein the first connector is a male connector and the second connector is a female connector.

21. The teeth-cleaning mouthpiece of claim 20, wherein:
a shape of the male connector complements a shape of the female connector;
the male connector is configured to insert into the female connector along an axis; and
the male connector has a substantially trapezoidal shape when viewed along the axis.

22. The teeth-cleaning mouthpiece of claim 21 wherein the substantially trapezoidal shape of the male connector comprises:
a top surface with a first width;
a bottom surface with a second width different from the first width; and
side walls extending between the top and bottom surfaces.

23. The teeth-cleaning mouthpiece of claim 20, wherein the male connector defines a slot configured to engage with a corresponding boss defined by the female connector when the male connector is engaged with the female connector.

24. The teeth-cleaning mouthpiece of claim 23, wherein:
the male connector further defines a front edge opposite the curved mouthpiece; and
the slot is recessed from the front edge of the male connector toward the curved mouthpiece.

25. The teeth-cleaning mouthpiece of claim 20, wherein:
the male connector comprises a front edge opposite the curved mouthpiece and a base adjacent to the curved mouthpiece; and
at least one of a top surface, a bottom surface, and a side wall is tapered such that the male connector narrows, at least partially, from the base of the male connector toward the front edge of the male connector.

26. The teeth-cleaning mouthpiece of claim 20, wherein the male connector further comprises an electrical contact configured to electrically couple to a corresponding electrical contact in the female connector when the male connector is engaged with the female connector.

27. The teeth-cleaning mouthpiece of claim 26, further comprising one or more lights electrically coupled to the electrical contact,
wherein at least one light of the one or more lights is configured to illuminate in response to receiving a signal from the drive mechanism via the electrical contact.

28. The teeth-cleaning mouthpiece of claim 20, wherein:
the male connector further comprises a latching mechanism that pivotally extends from a surface of the male connector; and
the latching mechanism is configured to engage with a corresponding notch defined in an inner surface of the female connector.
